(19) United States
(12) Patent Application Publication
(10) Pub. No.: US 2023/0177494 A1
(43) Pub. Date: Jun. 8, 2023

(54) Systems and Methods for Providing Secure Computing Structures

(71) Applicant: Token Fan-Commerce, LLC, Wheaton, IL (US)

(72) Inventors: Chris Davis, Austin, TX (US); Adam Jones, Wheaton, IL (US)

(21) Appl. No.: 18/061,362

(22) Filed: Dec. 2, 2022

Related U.S. Application Data
(60) Provisional application No. 63/285,353, filed on Dec. 2, 2021.
(60) Provisional application No. 63/349,979, filed on Jun. 7, 2022.

(51) Int. Cl. G06Q 20/36; H04L 9/08

(52) U.S. Cl. CPC G06Q 20/3678; H04L 9/088; G06Q 2220/00

(57) ABSTRACT

In one aspect, an example computer-implemented method includes (a) receiving, by a computing system, data associated with a user; (b) generating, by the computing system, one or more entries in a persistently stored structure based on the data; (c) determining, by the computing system, a value from the one or more entries; (d) providing, by the computing system and to a client computing device, a report comprising, at least in part, information associated with the one or more entries; and (e) issuing, by the computing system and to the user, a digital token that is based on, at least in part, the value from the one or more entries.

This application claims priority to U.S. Provisional Patent Application Nos. 63/285,353, filed on Dec. 2, 2021 and 63/349,979, filed on Jun. 7, 2022, each of which is hereby incorporated by reference in its entirety.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example computer-implemented method is disclosed. The method includes (a) receiving, by a computing system, data associated with a user; (b) generating, by the computing system, one or more entries in a persistently-stored structure based on the data; (c) determining, by the computing system, a value from the one or more entries; (d) providing, by the computing system and to a client computing device, a report comprising, at least in part, information associated with the one or more entries; and (e) issuing, by the computing system and to the user, a digital token that is based on, at least in part, the value from the one or more entries.

### BRIEF DESCRIPTION OF THE DRAWINGS

FIG. 1 is a simplified block diagram of an example computing device.

FIG. 2 is a simplified block diagram of an example computing system.

FIG. 3A is an example graphical user interface (“GUI”) in a first state.

FIG. 3B is the example GUI of FIG. 3A, but in a second state.

FIG. 3C is the example GUI of FIGS. 3A, but in a third state.

FIG. 3D is the example GUI of FIG. 3A, but in a fourth state.

FIG. 3E is the example GUI of FIG. 3A, but in a fifth state.

FIG. 4 is a block diagram of an example computing system.

FIG. 5 is a flow chart of an example method.

### DETAILED DESCRIPTION

### I. Overview

Currently, user data is spread across multiple systems and protocols leaving contextual and historical value lost in the isolation of said disparate systems.

Connecting these systems requires custom middleware solutions and extensions often leading to a decrease in security and efficiency due to multiple protocols and transformation of the data. As such, this data is mutable and thus fundamentally unsecured.

If, however, a computing system could provide a secure and novel solution for increasing security and efficiency, then the overall security and value from the data could be increased.

Accordingly, features of the present disclosure can help to address these and other issues to provide an improvement to select technical fields. More specifically, features of the present disclosure relates to methods and systems of connecting these systems through a proprietary computing system platform that includes a unifying protocol between devices that increases contextual data, historical data, and security through the use of one or more technologies, including a secured and decentralized network through a distributed computing network (e.g., a distributed ledger technology (DTL)). By doing so, the security of and value from the data is increased and enhanced for consumers by delivering messages to connected devices based specifically on this historical, contextual data as entries in the distributed computing network (e.g., a DTL ledger). These features will now be described.

Embodiments of the present invention provide methods, systems, and devices that allow a system to effectively analyze user data, incentive the user with more targeted content and/or monetary incentives by leveraging one or more digital technologies (e.g., DTL, digital token, blockchain and/or GPS technologies).

For example, the disclosed embodiments disclose, among other features, an improved platform that leverages the security, transparency, speed, and privacy of one or more digital technologies (e.g., DTL, digital token, blockchain and/or GPS technologies) to reward users for engaging with the brands they love, at each digital touchpoint in the fandom experience. In this regards, stakeholder on the platform has access to real-time data and analytics that can be used to further personalize, enhance and enrich their experiences and for the first time across all industries, users can be rewarded relative to their interactions with the brands and personalities they love the most.

A computer-implemented method may include a computing system (e.g., a cloud-based computing system). This computing system can be used to perform various operational functions to analyze data associated with a user (e.g., associated with purchasing habits of a user) and take one or more responsive actions based on the data.

For example, an individual consumer may exhibit purchasing habits actions and/or trends by one or more actions, one or more of which may be associated with different aspects in their everyday life. For example, an individual consumer may input data into a mobile computing device (e.g., a user of a smartphone) that indicates: (i) past purchasing habits for the user, (ii) potential purchases for the user, (iii) a digital ticket purchase associated with the user, and (iv) geographic location data indicating a current location of a mobile computing device associated with the user, among other possibilities. Additionally or alternatively, this data may be gathered and analyzed on a more collective level of multiple users (e.g., based on collecting and analyzing data from a host of consumers).

It should be readily understood that the computing system may receive data associated with a user and may do so from a number of sources. For example, the computing system may receive user input indicating interest in purchasing a specific good or service (e.g., tickets to a specific sporting event). Other examples are possible.

Once the data is received, however, the computing system may generate a representation of this data. For example, the computing system may generate one or more entries based on the data. In some embodiments, the computing system may store these one or more entries in a persistently-stored structure (e.g., a distributed network). In some examples, the computing system may be a computing node disposed within a distributed computing network, which includes a plurality of computing nodes that maintain a distributed ledger. In this example, these ledger entries may be part of the distributed ledger and generating these ledger entries may include: (i) storing the one or more ledger entries; and (ii) synchronizing the stored one or more ledger entries across all of the plurality of computing nodes. Other examples are possible.

In a further aspect, once the computing system has generated the one or more entries, the computing system may also determine a value associated with the entries (e.g., ledger entries) and/or the data itself. In some examples, this value may be based on one or more factors associated with ledger entries and/or the data itself, including one or more name brands of products purchased, a category of products purchased (e.g., consumer electronics, sunglasses, sporting event tickets, etc.), the types of products purchased, the frequency of products purchased, and/or the monetary value of products purchased, among other possibilities.

Further, in some example embodiments, the computing system may include a distributed ledger that includes an encrypted accounting history for transactions associated with the user and the value from the one or more ledger entries may be based on the length of the accounting history (e.g., the more the user of a smartphone purchases, the more valuable the ledger entries and/or data becomes). Other examples are possible.

In order to take various actions in connection with the user, the computing system may use one or more different technologies. For example, the computing system may interact with a mobile application executing on one or more computing devices to take various actions in connection with one or more parties using the one or more computing devices. This mobile application may be used by the consumers, clients (e.g., parties that are interested in data associated with a user of group of users), third parties, and/or other parties.

For example, the computing system may provide to a client computing device (e.g., via an application executing on the client computing device), a report (e.g., a report associated with a user, customer, etc., a “consumer report”) that includes information associated with the one or more ledger entries and/or the data itself, all of which may be scrubbed of personal-identifiable information (PII) associated with the user, depending on the user's preferences.

In other example embodiments, the computing system could generate and issue to a user (e.g., via an application executing on a mobile computing device), a report that is based on, at least in part, the value from the one or more ledger entries and/or the data associated with the user. In some examples, based on the value from this data, the computing system may issue one or more digital assets. In some examples, the digital assets may be any type of digital information (e.g., an encoded offer, a particular web page for purchasing unique goods, a non-fungible token, etc.) and/or any other kind of digital asset that provides a user/consumer incentive (e.g., a particular quantity of cryptographic tokens and/or some other monetary incentive, all of which may be referred to in this specification as a “digital token” or “consumer incentive”. In a further aspect, these tokens may be native to the computing system (e.g., a computing node disposed within a distributed computing network), from other token services, or some combination of the two, among other possibilities.

For example, in other, the digital token could be a non-monetary incentive, including the opportunity to purchase tickets to an event that is exclusive to and/or associated with the computing system and/or owner thereof. For example, the computing system may issue a digital token that includes tickets to an event that cannot otherwise be purchased or obtained outside of the computing system (i.e., a non-fungible event). In other example embodiments, these non-monetary incentives may include suggestions for potential purchases, exclusive rates and/or deals that can only be obtained via the computing system, among other possibilities.

Other example embodiments are also possible, many of which are discussed in further detail below.

### II. Example Architecture

A. Computing Device

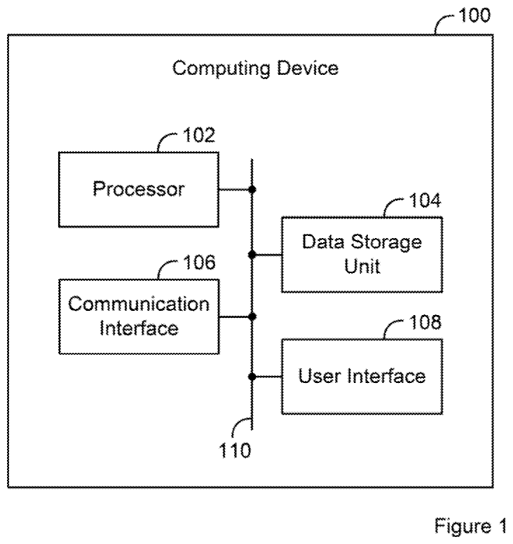

FIG. 1 is a simplified block diagram of an example computing device 100. The computing device 100 can be configured to perform and/or can perform one or more acts and/or functions, such as those described in this disclosure. The computing device 100 can include various components, such as a processor 102, a data storage unit 104, a communication interface 106, and/or a user interface 108. Each of these components can be connected to each other via a connection mechanism 110.

In this disclosure, the term “connection mechanism” means a mechanism that facilitates communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless).

The processor 102 can include a general-purpose processor (e.g., a microprocessor) and/or a special-purpose processor (e.g., a digital signal processor (DSP)). The processor 102 can execute program instructions included in the data storage unit 104 as discussed below.

The data storage unit 104 can include one or more volatile, non-volatile, removable, and/or non-removable storage components, such as magnetic, optical, and/or flash storage, and/or can be integrated in whole or in part with the processor 102. Further, the data storage unit 104 can take the form of a non-transitory computer-readable storage medium, having stored thereon program instructions (e.g., compiled or non-compiled program logic and/or machine code) that, upon execution by the processor 102, cause the computing device 100 to perform one or more acts and/or functions, such as those described in this disclosure. These program instructions can define, and/or be part of, a discrete software application. In some instances, the computing device 100 can execute program instructions in response to receiving an input, such as an input received via the communication interface 106 and/or the user interface 108. The data storage unit 104 can also store other types of data, such as those types described in this disclosure.

The communication interface 106 can allow the computing device 100 to connect with and/or communicate with another entity according to one or more protocols. In one example, the communication interface 106 can be a wired interface, such as an Ethernet interface. In another example, the communication interface 106 can be a wireless interface, such as a cellular or WI-FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

The user interface 108 can include hardware and/or software components that facilitate interaction between the computing device 100 and a user of the computing device 100, if applicable. As such, the user interface 108 can include input components such as a keyboard, a keypad, a mouse, a touch-sensitive panel, and/or a microphone, and/or output components such as a display device (which, for example, can be combined with a touch-sensitive panel), a sound speaker, and/or a haptic feedback system.

The computing device 100 can take various forms, such as a workstation terminal, a desktop computer, a laptop, a tablet, a mobile phone, and/or a mobile computing device.

B. Example Computing System

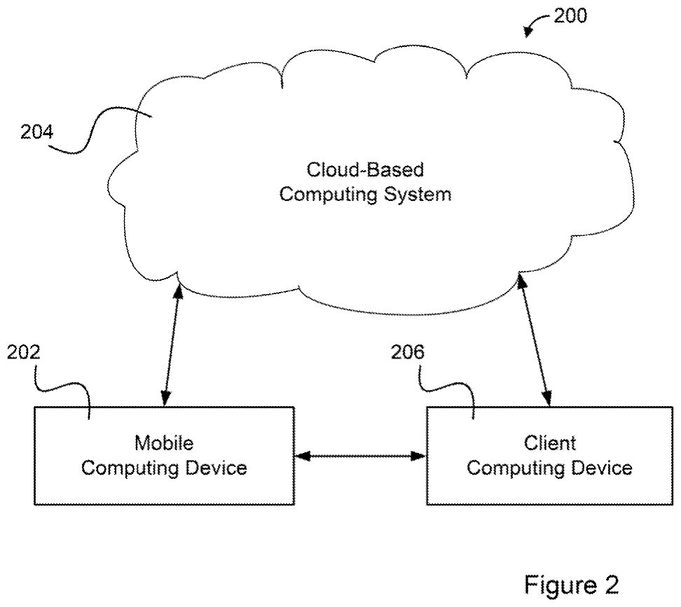

FIG. 2A is a simplified block diagram of an example computing system 200. The computing system 200 can perform various acts and/or functions related to the concepts detailed herein. In this disclosure, the term “computing system” means a system that includes at least one computing device. In some instances, a computing system can include one or more other computing systems, including one or more computing systems controlled by the service provider, a user, a client, different independent entities, and/or some combination thereof.

It should also be readily understood that computing device 100, computing system 200, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, the computing system 200 can include various components, such as mobile computing device 202, cloud-based computing system 204, and client computing device 206, each of which can be implemented as a computing system.

The computing system 200 can also include connection mechanisms (shown here as lines with arrows at each end (i.e., “double arrows”), which connect mobile computing device 202, cloud-based computing system 204, and client computing device 206, and may do so in a number of ways (e.g., a wired mechanism, wireless mechanisms and communication protocols, etc.).

In practice, the computing system 200 is likely to include many of some or all of the example components described above, such as mobile computing device 202, cloud-based computing system 204, and client computing device 206, which can allow many users to communicate and/or interact with the service provider and/or one or more clients, many clients to communicate and/or interact with the service provider and/or one or more users, and so on.

### IV. Example Operations

The computing system 200 and/or components thereof can perform various acts and/or functions (many of which are described above). Examples of these and related features will now be described in further detail.

Within computing system 200, a user associated with a mobile computing device 202 may interact with mobile computing device 202 and may do so in number of ways. For example, the mobile computing device 202 may receive input from a user indicating interest in purchasing a specific good or service (e.g., tickets to a specific sporting event), GPS data associated with a geolocation of the mobile computing device 202 (and thereby the user), and/or other types of data associated with a user. In some examples, this data associated with a user may be inputted into a mobile application associated with cloud-based computing system 204 and executing on mobile computing device 202.

Cloud-based computing system 204 may take one or more forms and/or include one or more components configured in a variety of ways. For example, cloud-based computing system 204 may include a computing node disposed within a distributed computing network. In a further aspect, this distributed computing network may include a plurality of computing nodes, which may perform a number of functions. For example, this plurality of nodes may maintain a distributed ledger.

In a further aspect, cloud-based computing system 204 may communicate with one or more other computing systems and/or computing devices (including computing device 202 and/or client computing device 206) and may any number of actions based on these communications.

For example, cloud-based computing system 204 may receive data associated with a user via mobile computing device 202 and take one or more actions based thereon. For example, cloud-based computing system 204 may receive, from client computing device 206, a user prompt and/or a value associated with the user prompt (e.g., “Buy our product now and save 20%!”). In response, cloud-based computing system 204 may generate instructions for causing a mobile computing device to display a graphical user interface representing the user prompt and then transmit, to mobile computing device 202 (associated with a user), the instructions. Additionally, this data may be of a particular value to a particular client and/or based in part on interactions with the user prompt (e.g., the more interaction, the more valuable).

In any event, once the cloud-based computing system 204 has received the data associated with a user, cloud-based computing system 204 may generate one or more entries based on the date. In some embodiments, the one or more entries may be one or more ledger entries based on the data. In some examples, cloud-based computing system 204 may store the one or more ledger entries. In some examples, storing the one or more ledger entries by computing system 204 may include: (i) encrypting the one or more ledger entries using a private cryptographic key associated with the user; and/or (ii) correlating the one or more ledger entries with an identifier associated with the user, among other possibilities. In a further aspect, cloud-based computing system 204 may synchronize the stored one or more ledger entries across all of the plurality of computing nodes (e.g., using DLT). Other examples are possible.

In any event, once the one or more ledger entries are generated, cloud-based computing system 204 may determine a value from the one or more ledger entries and may do so in a number of ways. For example, cloud-based computing system 204 may determine the value from one or more characteristics of the one or more ledger entries (e.g., expensive vs. inexpensive purchases) and determine a value based on an intrinsic characteristic associated with the one or more ledger entries and/or the underlying data. In still other examples, cloud-based computing system 204 may include a distributed ledger that maintains an encrypted accounting history for transactions associated with the user and determine a value from the one or more ledger entries is based a characteristic of the accounting history (e.g., length of accounting history, types of goods purchased over the accounting history, frequency of entries in the accounting history, etc.).

In a further aspect, cloud-based computing system 204 may receive one or more requests from the user of mobile computing device 202 and take one or more responsive actions based thereon. For example, cloud-based computing system 204 may receive a request from the user to view transactions contained on the distributed ledger and associated with the user. In turn, cloud-based computing system 204 may then generate instructions for causing a mobile computing device to display a graphical user interface representing the accounting history for transactions associated with the user and then transmit those instructions to mobile computing device 202.

In a further aspect, cloud-based computing system 204 may also interact with client computing device 206 and may do so in a number of ways. In one example, cloud-based computing system 204 may provide a report that contains information associated with the one or more ledger entries. This report may be based on cloud-based computing system 204 receiving a request from client computing device 206, including a request for a specific type of report (e.g., a particular type of consumer), among other possibilities. In other examples, cloud-based computing system 204 may send the reports to client computing device 206 on a recurring basis.

In any event, these reports may contain a variety of information, including information the user has specifically authorized (or not authorized) to be distributed. In some examples, the user of mobile computing device 202 may authorize the cloud-based computing system 204 to gather data on the user and reproduce it to client computing device 206 (or similar entities) with unlimited details about the user (e.g., age, height, city, ethnicity, marital status, etc.), as long as the cloud-based computing system 204 does not release any PII for the user to the client computing device 206 (or similar entities). In some examples, the user of mobile computing device 202 may authorize the cloud-based computing system 204 to gather data on the user and only reproduce it to client computing device 206 (or similar entities) with very limited details about the user (e.g., age of the user, and nothing else).

As will be understood of those in the art, these varying degrees of detail for the types and extent of information the user of mobile computing device 202 authorizes the cloud-based computing system 204 to gather and reproduce to client computing device 206 (or similar entities) may affect the value determined for the corresponding ledger entries and/or data (e.g., higher detail ledger entries may correlate to values). Additionally or alternatively, the user of mobile computing device 202 may change the level of details and/or data that the cloud-based computing system 204 may gather for the user (potentially in realtime), as well as the level of details and/or data that the cloud-based computing system 204 may reproduce it to client computing device 206 (or similar entities) on the user's behalf. Additionally, such actions may affect the value determined for the corresponding ledger entries and/or data associated with the user (potentially in realtime) and/or the type and/or value of the issued digital token (potentially in realtime).

To do so, cloud-based computing system 204 may make a determination that the user of mobile computing device 202 has authorized the client computing device 206 to access the one or more ledger entries and, in response to the determination, include information associated with the one or more ledger entries in the report. Additionally or alternatively, cloud-based computing system 204 may detect that the user has not authorized the release of personally-identifiable information for access by the client computing device 206. In response thereto, cloud-based computing system may remove any personally-identifiable information from inclusion in the report. Other examples are possible.

For example, cloud-based computing system 204 may receive information that the user of mobile computing device 202 has authorized the client computing device 206 to access the one or more ledger entries and, in response to the determination, authorize direct communication between the mobile computing device 202 and the client computing device 206 (shown in FIG. 2A as the double arrow between mobile computing device 202 and client computing device 206). Other examples are possible

In a further aspect, providing these reports may also produce one or more effects on one or more components of the cloud-based computing system 204, including correlating one or more identifiers with one or more ledger entries of the cloud-based computing system 204. In some examples, correlating one or more identifiers with one or more ledger entries, cloud-based computing system 204 may generate one or more second ledger entries containing, at least in part: (i) the identifier associated with the user, (ii) an identifier associated with the client computing device, and (iii) a digest of the information provided to the client device in the report. In a further aspect, cloud-based computing system 204 may also storing these one or more second ledger entries and then synchronize the stored one or more second ledger entries across all of the plurality of computing nodes. In yet a further aspect, cloud-based computing system 204 may update the report based on these second ledger entries and provide an updated report to the client computing device 206.

In a further aspect, cloud-based computing system 204 may issue a digital token to the user of mobile computing device 202 that is based on, at least in part, the value from the one or more ledger entries and/or data associated with the user. In one example, the digital token may include a quantity of cryptographic tokens, which may be native to the cloud-based computing system 204. To facilitate this issuance of the digital token, cloud-based computing system 204 may generate one or more second ledger entries containing, at least in part, a direct or indirect transaction for the quantity of cryptographic tokens. In a further aspect, in some examples, these transactions may occur between: (i) a cryptographic wallet associated with the client computing device, and (ii) a cryptographic wallet associated with the user, among other possibilities. In a further aspect, cloud-based computing system 204 may store the one or more second ledger entries and perform one or more further actions depending on the configuration of cloud-based computing system 204 (e.g., synchronizing the stored one or more second ledger entries across all of a plurality of computing nodes of cloud-based computing system 204).

In a further aspect, cloud-based computing system 204 may perform additional functionalities in connection with cryptographic tokens that are not native to the cloud-based computing system 204. For example, cloud-based computing system 204 may receive a second quantity of cryptographic tokens that are native to another distributed computing network, exchange the second cryptographic tokens for cryptographic tokens that are native to cloud-based computing system 204, and generate updated ledger entries based on the same.

In yet a further aspect, cloud-based computing system 204 may receive input from client computing device 206 and take one or more responsive actions based thereon. For example, cloud-based computing system 204 may receive a request from client computing device 206 to interact with one or more mobile computing devices (e.g., mobile computing device 202) communicatively connected to the cloud-based computing system 204.

In a further aspect, cloud-based computing system 204 may identify, from the one or more mobile computing devices, a set of mobile computing devices that have authorized interactions (e.g., interactions and/or data that is authorized by one or more users of the set of mobile computing devices for release to the client computing device 206). In some examples, these interactions represented in these requests may include updating a graphical user interface component on each respective mobile computing device and/or a query for data associated with each respective mobile computing device, among other possibilities.

In a further aspect, for each respective mobile computing device from the set of mobile computing devices, cloud-based computing system 204 may determine a value, based on, at least in part: (i) content of the request, and (ii) information associated with the respective mobile computing device (e.g., mobile computing device 202). In response, cloud-based computing system 204 may communicate, to each respective mobile computing device (or a subset thereof), the interaction represented in the request and, in turn may issue, to each respective mobile computing device (or a subset thereof), a digital token that is based on, at least in part, the determined value.

C. Example Graphical User Interfaces

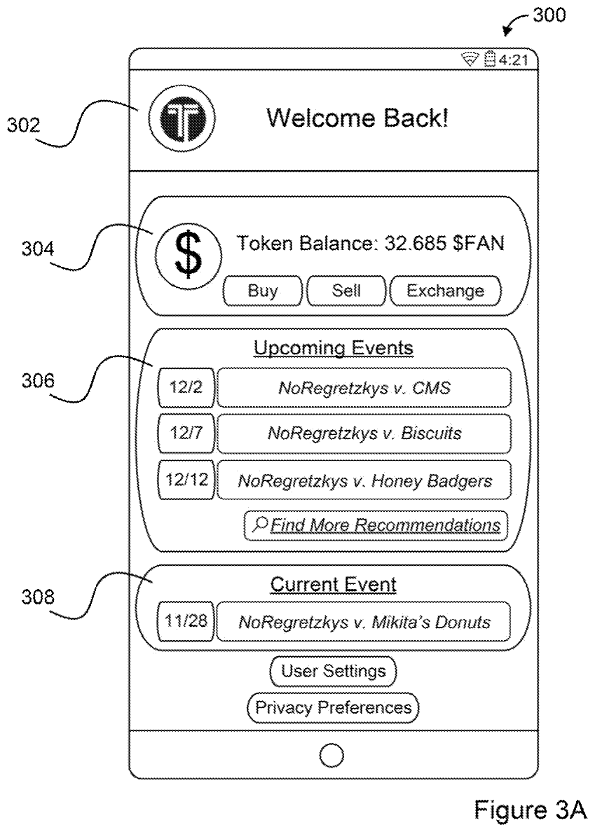

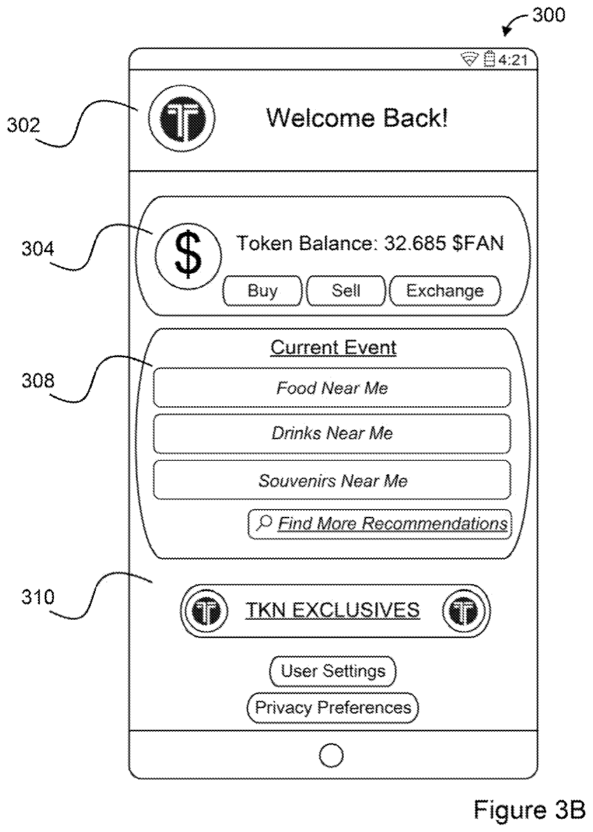

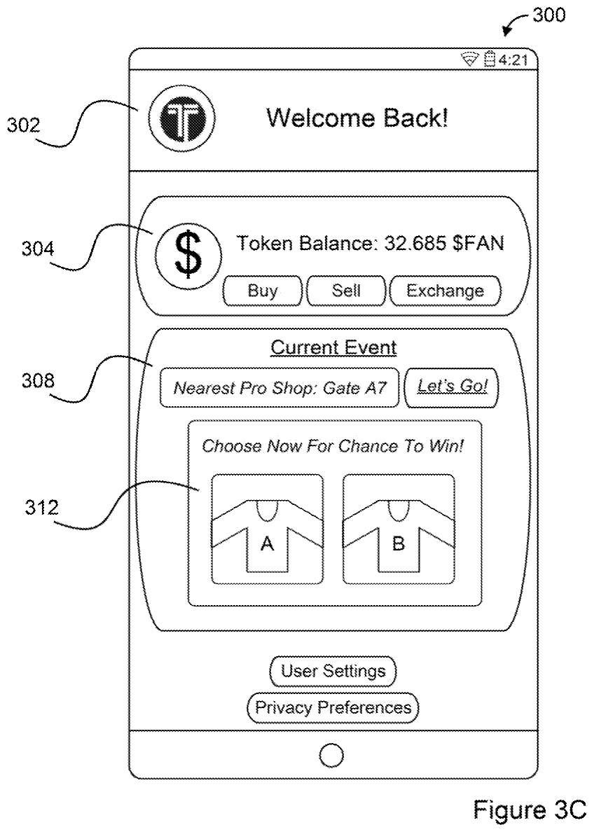

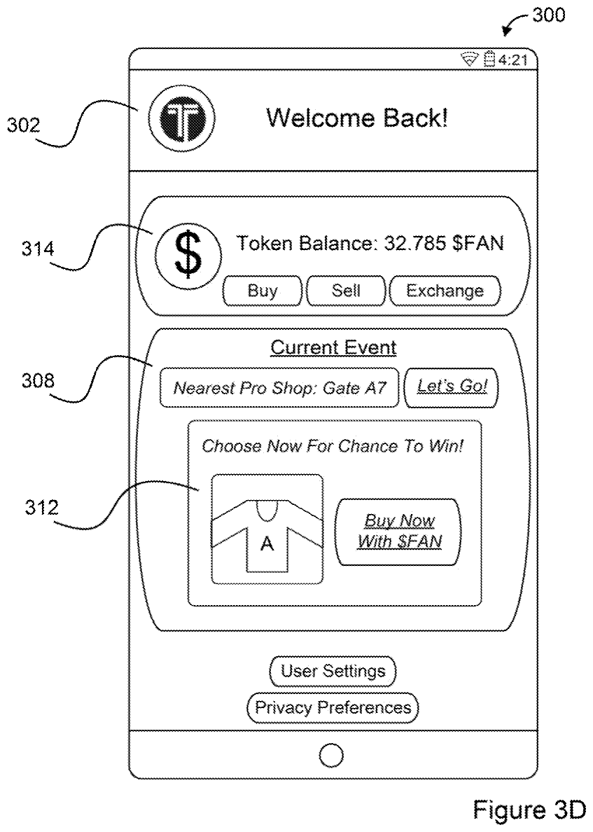

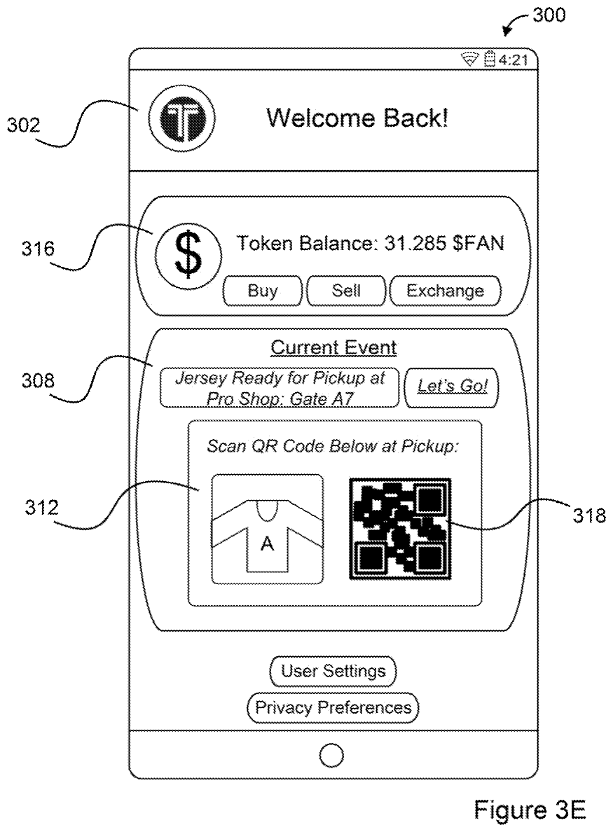

For example, to further illustrate the above-described concepts and others, FIGS. 3A-3E depict graphical user interfaces, in accordance with example embodiments. Although illustrated in FIGS. 3A-3E as being displayed via an application 302 associated with a digital token computer system. Although this application 302 is illustrated as displaying via a graphical user interface of a mobile computing device, this application may be provided for display by one or more components of the digital token computing system 200 (including cloud-based computing system 204 and/or client computing device 206), among other possibilities.

The information displayed by the graphical user interfaces may also be derived, at least in part, from data stored and processed by the components described in connection with the cloud-based computing system 204, and/or other computing devices or systems configured to generate such graphical user interfaces and/or receive input from one or more users (e.g., those described in connection with computing system 200, as well as the components of FIGS. 1 and 2). In other words, this graphical user interface is merely for the purpose of illustration. The features described herein may involve graphical user interfaces that format information differently, include more or less information, include different types of information, and relate to one another in different ways.

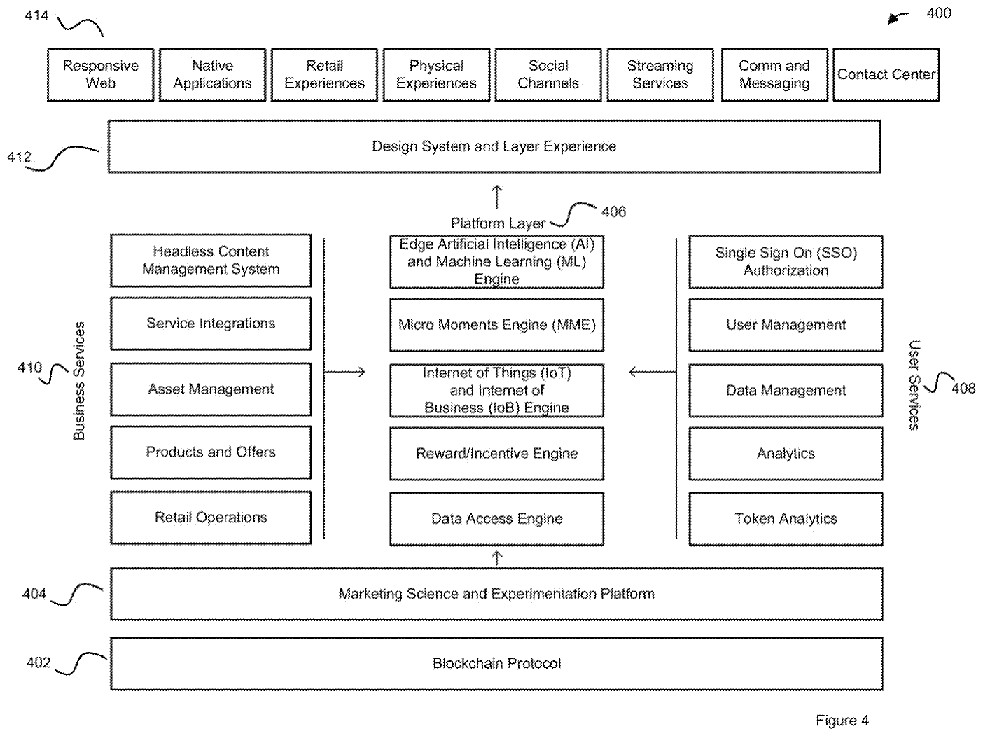

Turning to FIGS. 3A-4E, FIG. 3A depicts an example graphical user interface 300 in a first state. Interface 300 includes visual representations for the user of an application 302 executing on the depicted mobile computing device and associated with a computing system (e.g., cloud-based computing system 204). Interface 300 presents the user with visual indications of several components of the methods and systems described herein and actions that may be taken in response thereto.

Specifically, in the context of FIG. 3A, these visual indications include information concerning the cryptographic token balance 304 associated with the user (shown here as “Token Balance: 32.685 $FAN”), an upcoming events prompt 306 associated with a user of the computing system (shown here as “Upcoming Events”), and a current event prompt 308 associated with a user of the computing system (shown here as “Current Event”). Depending on the user's interaction with interface 300, several example actions may occur. For example, if the user selects current event prompt 308, the computing system may transmit instructions and/or information to the mobile computing device that causes the interface 300 to display additional information, incentives, or content that is target to the user of the mobile computing device (e.g., those described in connection with FIGS. 1 and 2, above).

For example, similar to FIG. 3A, FIG. 3B shows the graphical user interface 300 of FIG. 3A, but in a second state that results from a user selecting current event prompt 308. In the second state, because the user has selected the current event prompt 308, the computing system has provided information, incentives, or content that is personalized for the user of the application 302 and the associated mobile computing device. In FIG. 3B, interface 300 now displays additional information and recommendations that are specifically tailored to the user via current event prompt 308, both in terms of the current event in which the user is participating and the actual geographic location of such recommendation (shown here as “Food Near Me,” “Drinks Near Me,” and “Souvenirs Near Me”). Interface 300 also now displays an exclusive incentive prompt 310 that is only available for users of application 302, which may include the opportunity to purchase goods (e.g., jerseys, shirts, signature dishes and/or cocktails) that are exclusive to and/or associated with application and/or owner thereof, among other possibilities.

Turning to FIG. 3C, similar to FIGS. 3A-3B, FIG. 3C shows the graphical user interface 300 of FIGS. 3A-3B, but in a third state that results from a user selecting “Souvenirs Near Me” via current event prompt 308. In the third state, because the user has selected the “Souvenirs Near Me” via current event prompt 308, the computing system has provided additional content that is personalized for the user of the application 302 and the associated mobile computing device. In FIG. 3C, interface 300 now displays additional information and recommendations for souvenirs that are specifically tailored to the user via current event prompt 308. Specifically, interface 300 now provides a display of the nearest geographic location that the user can buy souvenirs (shown here as “Nearest Pro Shop: Gate A7”), as well as prompt to navigate to that location (shown here as “Let's Go!”). Interface 300 also now displays a digital token prompt 312 that allows users of application 302 to choose between two jerseys and offers a potential incentive for the user to do so (shown here as “Choose Now For Chance To Win”).

Turning to FIG. 3D, similar to FIGS. 3A-3C, FIG. 3D shows the graphical user interface 300 of FIGS. 3A-3C, but in a fourth state that results from a user selecting jersey “A” via digital token prompt 312. In the fourth state, because the user has selected jersey “A” via digital token prompt 312, the computing system has provided additional content that is personalized for the user of the application 302 and the associated mobile computing device. In FIG. 3D, interface 300 now displays additional information for buying jersey “A” via digital token prompt 312 (shown here as “Buy Now With $FAN”), as well as a display of the nearest geographic location that the user can buy jersey “A” (shown here as “Nearest Pro Shop: Gate A7”), as well as prompt to navigate to that location (shown here as “Let's Go!”). Importantly, interface 300 now also displays an updated cryptographic token balance 314 associated with the user (shown here as “Token Balance: 32.785 $FAN”), which may be based, in part, on the user interacting with digital token prompt 312 and choosing between the two displayed jerseys.

To accomplish the conversion of this input data and the functionality described in, the computing system associated with application 302 may perform some or all of the methods described in the disclosure and in connection with other figures herein (e.g., as detailed above in connection with, at least, FIGS. 2 and 4). For example, this functionality may include generating one or more ledger entries based on this input data, determining a value from those one or more ledger entries, and issuing, to the user, a digital token (in this case a partial “$FAN” cryptographic token) that is based on, at least in part, the value from the one or more ledger entries. Other examples are possible.

Turning to FIG. 3E, similar to FIGS. 3A-3D, FIG. 3E shows the graphical user interface 300 of FIGS. 3A-3D, but in a fifth state that results from a user selecting “Buy Now With $FAN” via digital token prompt 312. In the fifth state, because the user has selected “Buy Now With $FAN” via digital token prompt 312, the computing system has provided additional content that is personalized for the user of the application 302 and the associated mobile computing device. In FIG. 3E, interface 300 now displays additional information for picking up the now-purchased jersey “A” via digital token prompt 312 (shown here as “Scan QR Code Below at Pickup”), as well as a display of the nearest geographic location where the user can pick up the purchased jersey “A” (shown here as “Jersey Ready for Pickup at Pro Shop: Gate A7”), as well as prompt to navigate to that location (shown here as “Let's Go!”). In FIG. 3E, interface 300 now also displays QR code 318, which may be used for credentialing with the pickup location (e.g., to verify the user is the proper party to pick up the purchased jersey), among other possibilities. Importantly, interface 300 now also displays a second updated cryptographic token balance 316 associated with the user (shown here as “Token Balance: 31.285 $FAN”), which may be reflect, in part, the user purchasing jersey “A” via digital token prompt 312 and having the purchase price of jersey “A” automatically deducted from the user's cryptographic balance.

These example graphical user interfaces are merely for purposes of illustration. The features described herein may involve graphical user interfaces that are configured or formatted differently, include more or less information and/or additional or fewer instructions, include different types of information and/or instructions, and relate to one another in different ways.

FIG. 4 is a block diagram of an example computing system 400. The computing system 400 can perform various acts and/or functions related to the concepts detailed herein.

It should also be readily understood that computing system 400, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, the computing system 400 can include various components, such as Blockchain Protocol 402, Marketing Science and Experimentation Platform 404, Platform Layer computing devices 406 (which may include one or more or the illustrated Edge Artificial Intelligence (AI) and Machine Learning (ML) Engine, Micro Moments Engine (MME), Internet of Things (IoT) and Internet of Business (IoB) Engine, Reward/Incentive Engine, and/or Data Access Engine), User Services computing devices 408 (which may include one or more or the illustrated Single Sign On (SSO) Authorization, User Management, Data Management, Analytics, and/or Token Analytics), Business Services computing devices 410 (which may include one or more or the illustrated Headless Content Management System, Service Integrations, Asset Management, Products and Offers, and/or Retail Operations), Design System and Layer Experience computing device 412, and output computing devices 414 (which may include one or more or the illustrated Responsive Web, Native Applications, Retail Experiences, Physical Experiences, Social Channels, Streaming Services, Communications and Messaging, and/or Contact Center), each of which can be implemented as a computing system.

The computing system 400 can also include connection mechanisms (shown here as lines with arrows, which connect some or all of the illustrated components and may do so in a number of ways (e.g., a wired mechanism, wireless mechanisms and communication protocols, etc.).

In practice, the computing system 400 is likely to include many of some or all of the example components described above, which can allow many users to communicate and/or interact with the service provider and/or one or more clients, many clients to communicate and/or interact with the service provider and/or one or more users, and so on.

In an example embodiment, the components in FIG. 4 illustrates a computing system platform for allowing a decentralized currency for users to use whenever they interact on the platform, which provides a decentralized recording of every transaction and interaction by users, while still maintaining each individual's anonymity.

In this regard, the illustrated example computing system 400 prevents malicious actors (e.g., scalper insiders and bots) from distorting the market as each purchase is verified through biometric multi-factor authentication and fraud detection algorithms.

In a further aspect, computing system 400 discloses the common element that connects legacy systems to the 21st century blockchain by underlining all development layers with its Blockchain Protocol (which may be layer zero protocols and/or other blockchain protocols). Computing system 400 accomplishes all of this with an incredibly efficient computational overhead (e.g., low gas fees), an innovation that other crypto networks (e.g., Bitcoin® and Etherum®) simply cannot claim.

In a further aspect, the transaction also remains feeless, turning the ticket into an encrypted digital token (e.g., an “NFT”) collectible for users and also displays supply and demand data for users that let loyal users become “insiders” themselves. In this regard, the purchasing habits of users (e.g., purchasing the tickets themselves) can become a new market vertical that opens up new real-time incentives or special user experiences, all with the illustrated computing system's blockchain base serving as a permanent ledger of their loyalty and live event experience. Providing a more secure and engaging platform, the illustrated computing system 400 protects the fan and enhances illustrated business's ability to build a loyal fan base over time, brick by brick, and the impact on the ticket and live event reservation sector will decentralize the monopolistic hold giant conglomerates exert on venues, performers, and loyal fans. In this regard, users who agree to share their data with their favorite performers and venues will accumulate rewards over time that only encourage further engagement.

To do so, as illustrated in FIG. 4, computing system 400 transforms all modalities of digital fandom within an event ecosystem (e.g., a live event ecosystem), based on several key innovations within its DLT-based services, including:

1) Single Sign-on (SSO): Revolutionary Customer Identification Management: Recently, SSO technology has been integrated into a seamless online customer experience. However, traditional SSO technology suffers from major security risks. If hackers extract user login info, they can penetrate every single application in use. These security risks to traditional SSO services are why innovations in the DLT space are so vital to the future of secure SSO infrastructure. “Know your Customer” (KYC) tactics are going to be completely transformed; customer identification will be more seamless and securely encrypted through the illustrated components of computing system 400. In example embodiments, businesses (e.g. live event companies) are secured from suffering massive data breaches as the users of computing system 400 shape their digital experience by only authorizing personal data to specific brands. If users don't want one brand to know their identity, but want another brand to access every data point for a more customized experience, computing system 400 allows fans to make brands “earn” their loyalty through having superior reward offerings. No user data is sold to unauthorized third parties and computing system 400's encrypted DLT network prevents malicious hacks of any scale while simultaneously focusing on the user-brand relationship. In other words, storing the information on a distributed ledger is far more seamless and secure than traditional KYC methods and, for users looking to have a safe physical and digital “fandom” experience, computing system 400 is simply the ultimate DLT solution. Not only is the user's data encrypted within computing system 400, it is also only given out at their discretion. Adding this level of privacy to traditional SSO features protects users from being abused by their own data.

2) Fan to Entertainer Transaction (F2E): The Enhanced Capacity of direct user to business transactions (e.g., fan to entertainer transactions) allowed by the computing system 400 improves the security of transactions done through computing system 400's DLT blockchain and allows for businesses and users (e.g., fans and performers) to remove any barriers between one another. Providing users an original experience through a “shoutout” or special “loyalty rewards” is how entertainers create a fan base for life and brands, venues, and users are not the only beneficiaries of computing system 400's DLT network; individual users on the business side of computing system 400 (e.g., individual entertainers) can set up their own “subscription-style” service on computing system 400 in the mold of other individualized user models (e.g., OnlyFans, Patreon, and Twitch user models). From there, special user collectibles and experiences can be given away to the most loyal users. This could include “one of a kind” digital token (e.g., NFTs) conferring the status of the “ultimate fan,” or a user could purchase the chance to interact with the business during a specific moment in time (e.g., entertainers live during their performance). Individual businesses (e.g., entertainers) can take advantage of being their own “entity” on computing system 400's platform, allowing performers to always keep in touch with fans, offering custom rewards facilitated over the blockchain and the combination of interactive engagement and seamless transactions on the blockchain differentiates computing system 400 from traditional methods of “social media marketing.” Particularly, computing system 400 removes any need to link to a third party for the commerce shop; everything a performer needs to reach their fans can be found on the computing system 400 network.

3) Micro Moments Engine (MME): Revolutionary Event-Driven system powered by computing system 400's Edge Artificial Intelligence and marketing science: One of computing system 400's SaaS innovations is the Micro Moments Engine (MME)—a DLT network that maximizes the most “intent-rich” moments of all users. For example, every transaction, decision, behavior, and reaction inputted into computing system 400 can be considered a “micro moment” that together comprise a larger event and experience. As an example, ticket reservation, parking reservation, time entering venue, time concessions bought, and reaction to different promotions are all vital micro moments of an event. When connected by computing system 400's MME interface, smart automation in the live event space will completely revolutionize the live experience for fans by utilizing marketing analytics in ways not yet conceived. The potential of this novel MME technology to optimize each micro moment is vast; opens up live venues to entirely new levels of operational efficiency. In this regard, computing system 400 is so dynamic that it tailors the “digital” user/fan experience down to the individual level and based on how they respond and engage with computing system 400's interface, the games, deals, and activities are all personally customized through computing system 400's SaaS tools. For example, as discussed further above, computing system 400 allows venues to customize promotional items (e.g., shirts/jerseys) by giving each loyal user a unique experience and item (e.g., a jersey in their favorite color) and provide for more tailored and memorable experiences. In one example, prior to an event, organizers could ask fans on computing system 400, “What would be your favorite color shirt to get from the show?” The answers would inform venues exactly how many shirts to print and which colors to lay on which seats. In a further aspect, these micro-moments can be stored in computing system 400's network like sequential moments on a storyboard, relaying exactly how fans interact with the live event moment by moment. Accomplishing this level of granular detail at such a broad scale is the kind of high-level marketing science that can be done with computing system 400's MME. The customizable nature of the live event experience will be powerfully enhanced by computing system, and the entire live event ecosystem will be transformed by MME, micro moment by micro moment. Finally, MME makes possible real-time marketing science and experimentation. In example embodiments, computing system 400 may provide venues the capability to perform live AB testing by, for example, sending out different versions of promotional materials to predetermined seats in the crowd. Then, through computing system 400's interface, the venue could ask how much fans like each iteration of the promotional product. Based on the analyzed results, the venue will know what version of their products to bring back for future events and improved connectivity (e.g., 5G) allows the fan data to instantaneously populate answers to questions within computing system 400's marketing science software and decisions on the direction of live events can be made quicker, automated, and more informed than ever before with computing system 400's MME analysis software.

In a further aspect, computing system 400 may provide enhanced security for user data as every transaction (e.g., related to the live event (IoT), and every fan behavior (IoB)), can be captured for storage as individualized data on computing system 400. In example embodiments, this data contains personally identifiable information (PII) that is able to communicate with all networks while simultaneously remaining securely encrypted—providing total security throughout the blockchain network. Computing system 400's highly secure cryptographic protocols allow not only for dynamic transaction flows at an unlimited scale, but makes room for entire user ecosystems to form on specific platforms (e.g., a live event promotional platform). Unlike traditional business models (e.g., live event business models, there will no longer be interference from outside intermediaries that dilute the communal experience for users and brands, venues, and performers can consider data on computing system 400 clean from any defects, glitches, or corrupt records that would otherwise render the stored data unhelpful or inefficiently accessed.

In an example embodiment, computing system 400 allows users to use computing system 400's Single Sign-On Authorization to receive incentives (e.g., tokens) for interactions at events, on-going brand loyalty, and for spending the currency in their account in computing system 400. To do so, the user may utilize computing system 400 in a number of ways.

In one example embodiment, a user may earn incentives by completing fan engagement activities and experiences configured on computing system 400's MME. In example embodiments, computing system 400 captures every user activity, engagement, and response, and derives value from these experiences by analyzing how these “micro moments” can be conceptualized within the framework of the Internet of Behaviors (IoB).

In some example embodiments, computing system 400 may provide brand sponsors, venues, and performers with non-essential marketing data (e.g. surveys) and one unique feature of computing system 400's platform is the ease with which users control the security and authorization of their personally-identifying data. In a further aspect, computing system 400 establishes a live event ecosystem where users can exchange their valuable data to receive incentives (e.g., tokens, unique items) and no hidden data collection takes place due to the transparency of computing system 400's blockchain, buttressing the security of the platform's data-sharing services. In a further aspect, with every additional data point, the user will be incentivized to share with particular brands, and the amount of incentives they can receive increases. In a further aspect, by participating in normal application flows, users can be awarded incentives (e.g., tokens) to put towards savings at the next live event.

In some example embodiments, computing system 400 may provide brand sponsors and affiliated third parties could provide infinitely customizable pathways for users to earn incentives (e.g., tokens). In this regard, any interested business could configure a specific user experience or survey based on previous fan engagement. For example, if a stadium is testing a new beverage offering, they could make a special deal that users who buy the new drink get 75% off if they fill out a survey on how they felt about the new promotion via computing system 400. Thus, additional pathways to earn incentives are opened up through not only brand-sponsored user experiences, but any fan surveys or IoB data collected based on their response or attitude toward the promotion itself.

In some example embodiments, computing system 400 may provide incentives (e.g., tokens) for completing digital surveys designed by the business (e.g., performer, brand sponsor, or hosting venue). In a further aspect, completing subsequent surveys at future events earns even more incentives over time. Because users may choose what business they authorize these personally-identifying packets of data to be transferred to, users can feel more in control of their data while simultaneously benefitting from rewards offered directly—not by an unverified third party.

In some example embodiments, computing system 400 may provide users with the opportunity to stake their incentives (e.g., tokens) into liquidity pools to earn more incentives (e.g., tokens), and may do so in a number of ways. In one example, computing system 400 may utilize a data validation pool, for example a fixed size pool of certain quantity of tokens (e.g., Blockchain Protocol), and tokens may be required by the network to validate and secure the data flow. In a further aspect, the APR associated with this staking protocol can be a variety of values (e.g., 15%) and entry to this pool may be controlled by computing system 400 (e.g., via invitation only). In another example, computing system 400 may utilize user data to staking into a USER DATA pool, which may give users priority access to tickets and merchandise based on the user staking their earned incentives (e.g., tokens) into a liquidity pool. In addition, users staking into this pool may receive an APR paid for by FIAT from parties looking to utilize user data. Other examples are possible.

For example, computing system 400 may account and securely catalog every single touchpoint and interaction, the culmination of which may lead to different outcomes and experiences culminating into its own unique event and these unique snapshots of time hold different values to the individual user. In a further aspect, some outcomes and experiences carry personal weight and memories, others catch a moment in history that the larger collective will value. In example embodiments, computing system 400 allows these moments to be individually timestamped and saved for each user and/or a group of users.

In other examples, computing system 400 may improve the relationship and value from an interaction between a user and a business by requesting the user to allow computing system 400 to ingest from known data sources like brands already on computing system 400. In some examples, this arraignment supplies a base set of known user data allowing for reconciliation of discrepancies, as well as reaffirmation of common data points for the business. In this regard, computing system 400 will actively engage with the fan to expand on and fortify the very dataset that computing system 400 utilizes to perform the processes described herein and all of this data will be stored securely in the user's data enclave and will grow as the fan participates in the ecosystem.

In other examples, computing system 400 may actively collect user data through every interaction the user undertakes in in the computing system 400 ecosystem and store this data, securely, in the user's data enclave. Computing system 400 may also allow (or even proactively request) clarifications, preferences, and/or updates from the user for the user's profile, data sharing permissions, and other parameters for the user's interaction and experience with computing system 400.

In a further aspect, as illustrated in FIG. 4, using marketing experimentations, a business and/or brand can request data (e.g., implicitly in the form of surveys, or in incentivized (e.g. token) fashion), and receive and analyze the information through interactive experience governed by the MME. For example, if it can be deduced that a user is of a certain age and likes sports over esports, then MME may be utilized to create an experience that incentivizes them to purchase discounted tickets for upcoming, age-restricted sporting events. In a further aspect, marketing experimentation may be utilized to leverage IoB and IoT and IoB to fully utilize AI and ML. In example embodiments, this arrangement provides a unified experience enabling automations to be enabled in all domains and computing system 400's MME is designed to manage the connections between the users (e.g., fans), as well as the businesses (e.g., brands, venue, vendors, and third parties). In a further aspect, as illustrated in FIG. 4, MME allows the configuration of webhooks supporting multiple protocols with myriad authentication strategies to communicate to as many platforms as possible and the received data can then be extensively mixed and transformed with other live data to be consumable by the next message. In example embodiments, the MME serves as a serverless backend secured on blockchain technology and is accessible to all audiences. In this regard, as illustrated in FIG. 4, MME exposes its features to also be controlled through low code/no code interfaces and by manipulating UI components, one can use MME. In a further aspect, as illustrated in FIG. 4, arrangement caters to nontechnical brand personnel, as well as any users that want to use computing system 400. In a further aspect, by democratizing the user credential and experience, the total experience for each user is that every user of every type is an important (i.e., “power”) user.

In a further aspect, computing system 400's MME allows any user to create dynamic automations that enable improved user experiences and features native plugins to utilize connected IoT, IoB, and fan data sources, all of which allows for a direct integration into a business's marketing science analytics and reporting inside of computing system 400. In a further aspect, for any event, this data can be tapped into to target, direct, and influence their users/fans' experiences. In a further aspect, because this data is already a part of computing system 400, the users/fans' responses to these events get funneled back into the users/fans data used, enriching the marketing science dataset and sequential automations within computing system 400 and for the business. In this regard, MME turns Marketing Science into a true science by gathering and acting on factual user data through experience.

In a further aspect, as illustrated in FIG. 4, to store fan data securely and reliably, computing system 400 may use user data enclaves paired with Single Sign-on and identity access solutions to keep the user in control. In a further aspect, the user can modify, verify, add to, update, or even delete their entire profile. To authorize and safeguard fan data, computing system 400's Single Sign-on solution allows users to authenticate with and authorize requests. In one example, computing system 400 may use SSO in the sign on experience with the user (just as the user would see with any social media or email account), but unlike many other services, computing system 400 may not sell-off, and further monetize user data at the cost of the user, and instead use the SSO to gather that data to be leveraged by users for their own benefit via the incentive programs provided by computing system 400, as described herein.

In some example embodiments, to securely store user data, not just from malicious parties, but also other parties (e.g., businesses that the fan does not want to share their data with), computing system 400 may use a data enclave. In some examples, this data enclave stores user data in a cryptographic block of memory on the blockchain. In a further aspect, new data may be signed and encrypted with the latest metadata and transaction data via computing system 400. In example embodiments, this encryption may include the entity requesting the data, access terms, and the data fields requested and the data may be further encrypted, such that raw user data is not parsable on the blockchain. In this regard, breaching a user's enclave may require specific knowledge only the user would know, including of various encryption tools (e.g., Web3, computing system 400's own cryptography, and real-time transactional data).

Additionally or alternatively, in some examples, businesses may have some utility that can be applied to the data enclave beyond its storage in a secured black box. In some examples, businesses may elect to store datasets in isolation and data sources may indeed have their own node. This approach may allow for multidimensional dataset analysis of user. For example, a business could analyze all third-party data shared by their fans in isolation of their own brand-specific data. In a further aspect, this approach can even go into historical contexts where a business could measure how a fan has evolved year over year, or season to season in sports. In a further aspect, the fan may be required to authorize each request access to each iota of datum in the enclave's dataset, which results in a transparent and auditable result on both ends. In other examples, user may also enter into one or more of several policy types to access this data, including that specific pieces of user/fan data can be bought outright at a one-time cost. Realizing, however, that this data becomes stale as time progresses, users and/or businesses may elect to rent this data to businesses, where the user is rewarded with incentives (e.g. tokens) on periodic increments based on leasing terms, which may in turn create long-term access to the user's ever-changing data. Other examples are possible.

For example, computing system 400 may be used to build a decentralized identity for a user which are based on a combination of smart contracts, subchains, and organized structures that are verifiable internally by computing system 400, and externally verifiable through attested decentralized identifiers and digital token (e.g., NFT) utilities. In example embodiments, every entity in computing system 400 has their own root unique identity. In a further aspect, this identity may include reference to users, brands, bands, and even the events themselves, which may be tied to a subchain or node (i.e., digital tokens, including non-fungible event/experiences, “NFEs”). In a further aspect, data may be captured as micromoments and associated with one or more NFEs (e.g. a specific event NFE) and this transaction may link the actor to the recipient through the context of the event and its participants. In a further aspect, a business may create an event NFE of which the subsequent transaction of generating this event gets appended to the business's own NFE, and, in turn, this event NFE may now be considered its own root NFE. In a further aspect, this NFE may also contain a primary DID (decentralized Identifier) that indicates the owner/initiator of the event (e.g., the business) and/or contain other DIDs that allow multiple parties to be associated with the event. This approach allows businesses to create events at venues and venues to create events with brands for which both can be identified from the NFE data.

In other examples, contextual id and metadata may be attached to the event NFE, some or all of which may codify general event information, while allowing in-depth information to be referenced externally. In this regard, the technology and use of blockchain as it currently stands, does not warrant all information to be minted, thus, requiring the insecurity of web2. With general context information saved to the NFE, if all web2 data is compromised, there is still some context that is secured by web3. This can be improved in the interim with leveraging IPFS for encrypted storage like DID and presentation credentials do.

In a further aspect, the creation of new root NFEs have historically been focused on creating content and consuming this content has followed the same approach—that is when a user wants to interact with a businesses' event, a new root NFE is created linking the event NFE to the user's root NFEs. This new root NFE is often referred to as the event instance NFE. In a further aspect, although this is what the user will be seeing as the NFE for their event, every action performed by the user is captured and minted onto this NFE.

With every action/built/logged onto the event NFE, there is an in depth description of the event for the general audience (e.g., when the event started, ended, when highlights occurred, promotions sent out, etc.). Additionally, at the event instance NFE scope, the personalized experience may be viewable on a user by user basis and this paradigm applies recursively beyond event and event instance NFEs and into its parents, siblings, and children. This results in observations being derived from interactions between entities, users, and even events themselves. However, there are opportunities for improvement, particularly as illustrated by computing system 400.

In example embodiments, in a first aspect, when a new event is desired, a new root NFE may be created containing metadata for each hosting/participating entity. In a second aspect, computing system 400 may allow the event NFE to audit actions (e.g., product or ticket purchases), while encapsulating them between one or more particular metrics (e.g., price changes). In a further aspect, changes that happen to the event itself, (e.g., a location change, etc.) may also be minted onto the event NFE. By enabling these features, for each hosting/participating entity, their root NFEs are appended with the creation/addition of the event NFE. This allows for more auditing, and allows bidirectional linking between hosting entities and their new root NFEs they create. And, when an action occurs, the actors root NFE and the receiving event NFE are appended with additional data (e.g., who did what, and what was the effect), both of which are scoped to their specific NFEs while still being able to reference one another.

In example embodiments, each NFE transaction will have at least the following: (i) DID of the Sender (User/Fan); (ii) DID of the Receiver (Business/Brand); (iii) DID/faux DIDs of participants; (iv) EventId Context; and (v) other metadata that allows attestation of identity, authenticity of assets, and aids in efficient lookups.

To further illustrate this concept, turning back to FIGS. 3A-3D, in an example process flow, the NoRegretzkys may mint Game1 NFE (event NFE) with CMS and United Center DIDs (i.e., Generate placeholder/faux DIDs if they don't exist, for future linking). In a further aspect, a Game1 NFE creation is minted onto NoRegretzkys NFE, United Center, and CMS and when users purchase tickets, this mints the Event NFE (event instance NFE). In a further aspect, in example embodiments, the Event NFE creation is minted onto the respective User and Game1 NFE. Thereafter, in example embodiments, the NoRegretzkys may send out 50% promotion this gets minted onto the Game1 NFE and the respective User may receive promotions and mints reception on Event NFE, wherein the User may then use the promotion to purchase merchandise—and all of these actions are captured and minted onto the Event NFE.

To undertake and facilitate this process, one more systems described in this disclosure may utilize one or more components (e.g., one or more processors) to execute one or more portions of the following code:

interface NFE {

var metadata: any;

}
interface RootNFE extends NFE {

var owner: DID<string>;

}
interface EventNFE extends NFE {

var owner: DID<string>;
var context: DID<string>[ ]; // event id for external lookup
var mut entities: DID<string>[ ];
var mut action: string; // ‘created’
var mut balance: number; // number of current eiNFEs
var mut capacity: number; // max eiNFEs that can be created
var mut type: string; // type of eventNFE

}
interface EventInstanceNFE extends NFE {

var eventNFE: DID<string>; // (eventNFE.context)
var mut owner: DID<string>; // current owning fan/user

}
const createUser = (sender: DID<string>, user: DID<string>): rootNFE => {

const [rootNFE, txId] = mint(new RootNFE( ), { owner: user });
const senderRootNFE = getRootNFEForOwner(sender);
mint(senderRootNFE, { nfe: rootNFE.context, action: ‘created’, txId });

}
const createEvent = (sender: DID<string>, entities: DID<string>[ ], metadata:
Array<string|number|bool>): EventNFE => {

const senderRootNFE = getRootNFEForOwner(sender);
const [eventNFE, txId] = mint(new EventNFE( ), { owner: sender, entities, metadata });
mint(senderRootNFE, { nfe: eventNFE.context, action: ‘created’, txId });
entities.map(entity => {

let entityRootNFE;
if(entity == sender) entityRootNFE = senderRootNFE;
else entityRootNFE = getRootNFEForOwner(entity);
mint(entityRootNFE, { nfe: eventNFE.context, action: ‘associated’, txId });

});

}
const createEventInstance = (sender: DID<string>, reciever: DID<string>, eventID:
DID<string>): EventInstanceNFE => {

const senderRootNFE = getRootNFEForOwner(sender);
const receiverRootNFE = getRootNFEForOwner(receiver);
const [eiNFE, txId] = mint(new EventInstanceNFE( ), { owner: reciever, sender, event:

eventID });

mint(senderRootNFE, { nfe: eiNFE, action: ‘created’, txId });
mint(receiverRootNFE, { nfe: eiNFE, action: ‘acquired’, txId });

}

const submitEvent = (sender: DID<string>, reciever: DID<string>, contextID:

DID<string>, data: any): any => {

const senderRootNFE = getRootNFEForOwner(sender);
const eventOrInstanceNFE = getNFEMatching({ reciever, context: contextID });
const [storageData, metadata] = parse(data);
store({ context: eventOrInstanceNFE.context, data: storageData });
const [, txid] = mint(eventOrInstanceNFE, { action: data.action ?? ‘updated’, metadata, by:

sender });

mint(senderRootNFE, { nfe: eiNFE, action: ‘created’, txId });

}

In a further aspect, NFEs may be representative of the culmination of all data points storable on a blockchain and enriched with external storage that form the identifiable, attestable identity of an entity. In example embodiments, computing system 400 may not only store standard blockchain transactions (in historical cryptocurrency terms includes value, NFTS, and other digitally marked assets), but also, event level information such as checkpoints, ticket scans, page views, button presses, etc., and this aggregation of this data may also provide a fingerprint that identifies an entity. In a further aspect, while this data is so unique that it alone can be trusted as an identifiable source for an entity, decentralized standards must be used to further provide validity and verification of this data forming the NFE and decentralized identity may be an integral part of transactions forming the NFE allowing outside parties to verify the validity of identity and ownership of the NFE thus creating Non-fungible Ownership (“NFO”).

In a further aspect, NFE may also be both modularly configurable and chainable. For example, if User A's NFE links to his own Browsing NFE (the experience of browsing a computing application associated with computing system 400), this Browsing NFE can be fairly general and scoped to the wider experience of computing system 400. However, as User A navigates and converts to buying a ticket, a new NFE can be created to denote the ticket purchase for a NoRegretzkys vs Biscuits Game NFE (the experience of buying a ticket). In a further aspect, this process gives users of computing system 400 contextual knowledge around how browsing occurs, and then the NoRegretzkys on how NoRegretzkys Fans arrive to purchase a ticket for their game. In a further aspect, the ticket generates a NoRegretzkys vs Biscuits Game event instance NFE which will host the data relevant to the experience of the game. While the NoRegretzkys vs Biscuits Game NFE above is User A's there are shared data points which form the NoRegretzkys' specific NoRegretzkys vs Biscuits Game NFE and in turn any Biscuits' specific NFE. Other examples are possible.

In a further aspect, in example embodiments, to allow NFEs and NFOs to be accessible to the outside world, a Single Sign-on may enable third parties to authenticate users through accessible decentralized web3 standards such as attestation and centralized web2 standards such as OAuth. With the user secured, API access may be granted for third parties to allow them to report data points to be appended to the NFE. This protocol allows adoption by any company in web2 or web3 to leverage users of computing system 400 and continue to add to the identity of their users through building NFEs. Other examples are possible.

These example processes, components, and workflows are merely for purposes of illustration. The features described herein may involve processes, components, and workflows that are configured or formatted differently, include more or less information and/or additional or fewer instructions and/or components, include different types of information and/or instructions and/or components, and relate to one another in different ways.

### III. Example Methods

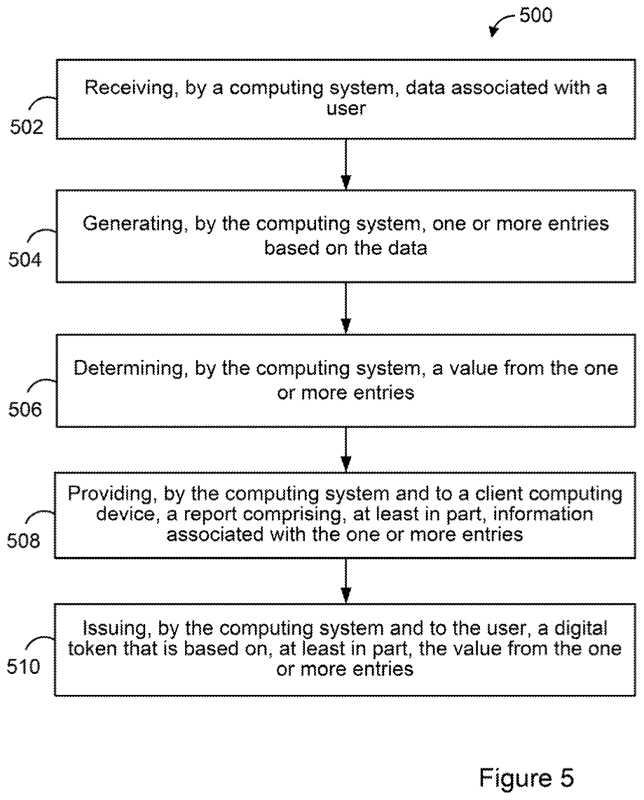

FIG. 5 is a flow chart illustrating an example method 500.

At block 502, the method 500 can include, receiving, by a computing system, data associated with a user. In some examples, the computing system may include a computing node disposed within a distributed computing network. In some examples, the distributed computing network may include a plurality of computing nodes that maintain a distributed ledger. In other examples, the distributed ledger includes an encrypted accounting history for transactions associated with the user.

In some examples, receiving the data includes: (i) receiving, from the client computing device, a user prompt and a value associated with the user prompt; (ii) generating instructions for causing a mobile computing device to display a graphical user interface representing the user prompt; and (iii) transmitting, to a mobile computing device associated with the user, the instructions, wherein the data is based in part on interactions with the user prompt and wherein the value from the one or more entries (e.g., ledger entries) is based in part on the value associated with the user prompt. In other examples, the data includes at least one of: (i) past purchasing habits for the user, (ii) potential purchases for the user, (iii) a digital ticket purchase associated with the user, and (iv) geographic location data indicating a current location of a mobile computing device associated with the user.

At block 504, the method 500 can include, generating, by the computing system, one or more entries based on the data.

In some examples, generating, by the computing system, one or more entries based on the data may include generating, by the computing system, one or more ledger entries based on the data may include generating the one or more ledger entries may include storing, at the computing system, the one or more ledger entries and synchronizing the stored one or more ledger entries across all of the plurality of computing nodes. In other examples, storing the one or more ledger entries may include encrypting the one or more ledger entries using a private cryptographic key associated with the user. In still other examples, storing the one or more ledger entries comprises correlating the one or more ledger entries with an identifier associated with the use.

At block 506, the method 500 can include determining, by the computing system, a value from the one or more entries.

In some examples, the one or more entries may be one or more ledger entries and the value from the one or more ledger entries is based, at least in part, on a length of the accounting history.

At block 508, the method 500 can include providing, by the computing system and to a client computing device, a report comprising, at least in part, information associated with the one or more entries.

In some examples, the one or more entries may be one or more ledger entries and providing the report can include making a determination that the user has authorized the client computing device to access the one or more ledger entries and, in response to the determination, enabling, for inclusion in the report, information associated with the one or more ledger entries. In other examples, providing the report includes generating one or more second ledger entries containing: (i) the identifier associated with the user, (ii) an identifier associated with the client computing device, and (iii) a digest of the information provided to the client device in the report. In other examples, providing the report includes storing the one or more second ledger entries and synchronizing the stored one or more second ledger entries across all of the plurality of computing nodes.

At block 510, the method 500 can include issuing, by the computing system and to the user, a digital token that is based on, at least in part, the value from the one or more entries. In some examples, the one or more entries may be one or more ledger entries and the digital token can include a quantity of cryptographic tokens.

In some examples, issuing the digital token includes generating one or more second ledger entries containing, at least in part, a direct or indirect transaction for the quantity of cryptographic tokens between: (i) a cryptographic wallet associated with the client computing device, and (ii) a cryptographic wallet associated with the user, storing the one or more second ledger entries, and synchronizing the stored one or more second ledger entries across all of the plurality of computing nodes. In some examples, the cryptographic tokens are native to the distributed computing network.

In still other examples, issuing the digital token includes: (i) receiving, by the client computing device, a quantity of second cryptographic tokens that are native to a second distributed computing network comprising a second plurality of computing nodes that maintain a second distributed ledger, (ii) exchanging the quantity of second cryptographic tokens for the quantity of cryptographic tokens, and (iii) after the exchanging, generating one or more second ledger entries.

In other examples, method 500 may further include: (i) receiving, by the computing system and from a mobile computing device associated with the user, a request to view transactions contained on the distributed ledger and associated with the user, (ii) generating, by the computing system, instructions for causing a mobile computing device to display a graphical user interface representing the accounting history for transactions associated with the user, and (iii) transmitting, by the computing system and to the mobile computing device, the instructions.

In still other examples, method 500 may further include: (i) detecting that the user has not authorized the release of personally-identifiable information for access by the client computing device, and (ii) in response to the detecting, checking any personally-identifiable information from inclusion in the report.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

Additionally, Appendix A, provided herewith as an Appendix to the specification, includes further embodiments, subject matter, methods, and systems related to this disclosure. The entire contents of Appendix A are hereby incorporated by reference in its entirety.

We claim:

1. A computer-implemented method comprising:
receiving, by a computing system, data associated with a user;
generating, by the computing system, one or more entries in a persistently-stored structure based on the data;
determining, by the computing system, a value from the one or more entries;
providing, by the computing system and to a client computing device, a report comprising, at least in part, information associated with the one or more entries; and
issuing, by the computing system and to the user, a digital token that is based on, at least in part, the value from the one or more entries.

2. The computer-implemented method of claim 1, wherein the computing system is a computing node disposed within a distributed computing network, wherein the distributed computing network comprises a plurality of computing nodes that maintain a distributed ledger, and wherein generating the one or more entries comprises:
generating, by the computing system, one or more ledger entries based on the data;
storing, at the computing system, the one or more ledger entries; and
synchronizing the stored one or more ledger entries across all of the plurality of computing nodes.

3. The computer-implemented method of claim 2, wherein storing the one or more ledger entries comprises encrypting the one or more ledger entries using a private cryptographic key associated with the user.

4. The computer-implemented method of claim 2, wherein storing the one or more ledger entries comprises correlating the one or more ledger entries with an identifier associated with the user.

5. The computer-implemented method of claim 4, wherein providing the report comprises:
generating one or more second ledger entries containing, at least in part: (i) the identifier associated with the user, (ii) an identifier associated with the client computing device, and (iii) a digest of the information provided to the client device in the report;
storing the one or more second ledger entries; and
synchronizing the stored one or more second ledger entries across all of the plurality of computing nodes.

6. The computer-implemented method of claim 2, wherein the distributed ledger comprises an encrypted accounting history for transactions associated with the user.

7. The computer-implemented method of claim 6, wherein the value from the one or more ledger entries is based, at least in part, on a length of the encrypted accounting history.

8. The computer-implemented method of claim 6, further comprising:
receiving, by the computing system and from a mobile computing device associated with the user, a request to view transactions contained on the distributed ledger and associated with the user;
generating, by the computing system, instructions for causing a mobile computing device to display a graphical user interface representing the accounting history for transactions associated with the user; and
transmitting, by the computing system and to the mobile computing device, the instructions.

9. The computer-implemented method of claim 1, wherein providing the report comprises:
making a determination that the user has authorized the client computing device to access the one or more entries; and
in response to the determination, enabling, for inclusion in the report, information associated with the one or more entries.

10. The computer-implemented method of claim 9, further comprising:
detecting that the user has not authorized the release of personally-identifiable information for access by the client computing device, and
in response to the detecting, checking any personally-identifiable information from inclusion in the report.

11. The computer-implemented method of claim 1, wherein receiving the data comprises:
receiving, from the client computing device, a user prompt and a value associated with the user prompt;
generating instructions for causing a mobile computing device to display a graphical user interface representing the user prompt; and
transmitting, to a mobile computing device associated with the user, the instructions, wherein the data is based in part on interactions with the user prompt and wherein the value from the one or more entries is based in part on the value associated with the user prompt.

12. The computer-implemented method of claim 1, wherein the computing system is a computing node disposed within a distributed computing network, wherein the distributed computing network comprises a plurality of computing nodes that maintain a distributed ledger, wherein the digital token comprises a quantity of cryptographic tokens, and wherein issuing the digital token comprises:
generating one or more second entries containing, at least in part, a direct or indirect transaction for the quantity of cryptographic tokens between: (i) a cryptographic wallet associated with the client computing device, and (ii) a cryptographic wallet associated with the user;
storing the one or more second entries; and
synchronizing the stored one or more second entries across all of the plurality of computing nodes.

13. The computer-implemented method of claim 12, wherein the cryptographic tokens are native to the distributed computing network.

14. The computer-implemented method of claim 12, wherein issuing the digital token further comprises:
receiving, by the client computing device, a quantity of second cryptographic tokens that are native to a second distributed computing network comprising a second plurality of computing nodes that maintain a second distributed ledger;
exchanging the quantity of second cryptographic tokens for the quantity of cryptographic tokens; and
after the exchanging, generating one or more second entries.

15. The computer-implemented method of claim 1, wherein the data includes at least one of: (i) past purchasing habits for the user, (ii) potential purchases for the user, (iii) a digital ticket purchase associated with the user, and (iv) geographic location data indicating a current location of a mobile computing device associated with the user.

16. A computer-implemented method comprising:
receiving, by a computing system and from a client computing device, a request to interact with one or more mobile computing devices communicatively connected to the computing system;
identifying, by the computing system and from the one or more mobile computing devices, a set of mobile computing devices that have authorized interactions from the client computing device;
for each respective mobile computing device from the set of mobile computing devices, determining, by the computing system, a value, wherein the value is based on, at least in part: (i) content of the request, and (ii) information associated with the respective mobile computing device;
communicating, by the computing system and to each respective mobile computing device, the interaction represented in the request; and
issuing, by the computing system and to each respective mobile computing device, a digital token that is based on, at least in part, the determined value.

17. The computer-implemented method of claim 16, wherein the computing system is a computing node disposed within a distributed computing network, wherein the distributed computing network comprises a plurality of computing nodes that maintain a distributed ledger, and wherein communicating the interaction represented in the request comprises:
generating, by the computing system, one or more ledger entries based on the communication;
storing, at the computing system, the one or more ledger entries; and
synchronizing the stored one or more ledger entries across all of the plurality of computing nodes.

18. The computer-implemented method of claim 17, wherein the digital token comprises a quantity of cryptographic tokens, and wherein issuing the digital token comprises:
generating, by the computing system, one or more second ledger entries containing, at least in part, a direct or indirect transaction for the quantity of cryptographic tokens between: (i) a cryptographic wallet associated with the client computing device, and (ii) a cryptographic wallet associated with the respective mobile computing device;
storing, by the computing system, the one or more second ledger entries; and
synchronizing the stored one or more second ledger entries across all of the plurality of computing nodes.

19. The computer-implemented method of claim 18, wherein the cryptographic tokens are native to the distributed computing network.

20. The computer-implemented method of claim 18, wherein issuing the digital token further comprises:
receiving, by the client computing device, a quantity of second cryptographic tokens that are native to a second distributed computing network comprising a second plurality of computing nodes that maintain a second distributed ledger;
exchanging the quantity of second cryptographic tokens for the quantity of cryptographic tokens; and
after the exchanging, generating one or more second ledger entries.

21. The computer-implemented method of claim 17, wherein the distributed ledger comprises, for each respective mobile computing device, an encrypted accounting history for transactions associated with the respective mobile computing device.

22. The computer-implemented method of claim 21, wherein the value from each respective mobile computing device is based, at least in part, on a length of the accounting history for each respective mobile computing device.

23. The computer-implemented method of claim 16, wherein the interaction represented in the request comprises updating a graphical user interface component on each respective mobile computing device.

24. The computer-implemented method of claim 16, wherein the interaction represented in the request comprises a query for data associated with each respective mobile computing device.
